(19) United States
(12) Patent Application Publication
(10) Pub. No.: US 2007/0119555 A1
(43) Pub. Date: May 31, 2007

(54) Methods for reducing wax content of pulp furnish

(76) Inventors: Fushan Zhang, Jacksonville, FL (US); Richard L. Brady, Wilmington, DE (US)

Correspondence Address: Joanne Mary Fobare Rossi;Hercules Incorporated, Hercules Plaza, 1313 North Market Street, Wilmington, DE, 19894-0001, US

(21) Appl. No.: 11/289,999

(22) Filed: Nov. 30, 2005

(51) Int. Cl. D21C 5/02; B03D 1/00

(52) U.S. Cl. 162/5; 162/4; 210/705

(57) ABSTRACT

The present invention is directed to methods for reducing wax content of pulp furnish by treatment with a wax agglomeration agent followed by removal of wax particles.

### FIELD OF THE INVENTION

The present invention is directed to methods for reducing wax content of pulp furnish by treatment with a wax agglomeration agent followed by removal of wax particles.

### BACKGROUND OF THE INVENTION

Recycled fiber is an important raw material in the paper industry because of its availability and low cost. Mixed office waste (MOW) and old corrugated containers (OCC) are examples of recycled fiber streams. OCC fiber is commonly used in the making of containerboard, either as a component with virgin fiber or in 100% recycled form. Although it is supposed to be excluded from the recycling stream, a small portion of wax-coated containerboard (for example, fruit and vegetable boxes) invariably gets recycled. The wax present can cause difficulties for the paper mill, including wax spots on the sheet, lower slide angle, decreased strength, and wax deposits on the equipment.

Recycled fiber streams can be contaminated with a variety of waxes. For cascade coated boxes, low melting paraffin wax is normally used, sometimes with a small amount of polyethylene wax. For curtain coated board, paraffin wax is normally used with microcrystalline wax, ethylene-vinyl acetate copolymers, and other additives.

The temperature in the recycle process in relation to the melting point of the wax can affect wax removal. Typical mill repulping temperatures are 115-140° F., compared to typical paraffin wax melting points of 120-160° F. If the wax is melted in the repulper, it can be more readily removed from the fibers. Melted wax will typically not be taken out in the screens and cleaners. Often a portion of it will go out with the water in the thickening step. Melted wax, however, can solidify anywhere the temperature drops, and cause deposit problems on both the equipment and the sheet. There is also an energy cost associated with melting the wax.

Below the melting point of wax, repulped waxed boxes can release some solid wax particles. In addition, some wax will usually remain coated on the fibers. Screens and reverse cleaners can remove the unrepulped pieces as well as some of the wax particles, but some wax will invariably make it through. This wax can melt in the dryer section and thus deposit on the sheet and equipment.

There are three major approaches which have been used to deal with the wax problem. One approach employs mechanical techniques such as screens, cleaners, and thickeners. Screens include coarse screens to remove large unrepulped pieces as well as fine screens to remove smaller fiber bundles. Reverse centrifugal cleaners are commonly used to remove low density contaminants, such as wax. Larger particles are removed more efficiently in the reverse cleaners. Thickening (partially dewatering the pulp) removes contaminants with the water. High temperature dispersion units can also be used but are less common because of the associated energy and capital costs.

A second approach to the wax problem is modification of the wax coatings themselves to make them more easily repulpable. U.S. Pat. No. 6,113,738 reports such approaches.

A third approach to controlling wax involves treatment with additives. Again, U.S. Pat. No. 6,113,738 reports some of these approaches. In many cases, such as U.S. Pat. Nos. 6,113,738, 6,248,793 and 6,548,558, the reported additives are designed to disperse and stabilize the wax. In addition, U.S. Pat. No. 6,656,324 reports use of d-limonene with sodium metasilicate for agglomeration of wax and removal by screening. However d-limonene, a citrus oil, can be a source of undesirable volatile organic compounds (VOCs).

As discussed above, unwanted wax in recycled paper fibers can be difficult to remove thereby limiting fiber recycling efficiency and output. Accordingly, there is a current need for improved methods for reducing the amount of unwanted wax from pulp furnish. The treatment methods and compositions provided herein, designed for agglomeration of wax particles for improved separation, are directed toward this end.

### SUMMARY OF THE INVENTION

The present invention provides methods for reducing wax content of a pulp furnish, comprising:
a) treating a pulp furnish comprising fibers and wax with a wax agglomeration agent effective to separate the wax from the fibers and form wax particles,
   wherein the wax agglomeration agent comprises a mineral oil, a polybutene, a petroleum-based aliphatic hydrocarbon, a synthetic alcohol, a vegetable oil, or an ester derivative of a vegetable oil; and
b) removing the wax particles from the pulp furnish to produce a pulp furnish having reduced wax content compared with the pulp furnish prior to the treating.

The present invention further provides pulp furnish treated according to the methods described herein.

The present invention further provides compositions comprising a wax agglomeration agent and a surfactant.

### DETAILED DESCRIPTION

The present invention provides, inter alia, methods for reducing the wax content of a pulp furnish by treating the pulp furnish with a wax agglomeration agent that effectively separates and agglomerates the wax from the fibers of the pulp to form separable wax particles which are removed to produce a pulp furnish having reduced wax content compared with the pulp furnish prior to treatment. While wax content of pulp furnish is normally reduced during the recycling process even in the absence of treatment agents, addition of a wax agglomeration agent according to the methods described herein increases the amount of wax rejects and consequently improves wax removal compared with untreated systems. Accordingly, the methods herein are useful, for example, in improving the recycling of paper products by decreasing problems associated with undesirable wax content in pulp furnish from recycled sources.

The pulp furnish for treatment according to the methods of the invention typically contains a mixture of fibers and wax. Wax-containing pulp furnishes can be prepared by repulping recycled paper sources such as linerboard from OCC (old corrugated containers) and the like. Other wax-containing pulp furnishes can also include internal re-use of wax-containing broke, such as in reusing wax-sized broke in the mill. The methods described herein can be used to remove wax in a pulp furnish, such as OCC furnish, that contains wax levels of about 0.05 to about 40% by dry weight. In some embodiments, the wax content is about 0.1 to about 5%. In further embodiments, the wax content is about 0.1 to about 3%.

Wax is a general term which can include a variety of substances. Accordingly, the present invention contemplates any type of wax. Waxes in pulp furnish tend to be derived from wax coatings on containers. For cascade coated boxes, low melting paraffin wax is normally used, sometimes with a small amount of polyethylene wax. For curtain coated board, paraffin wax is normally used with microcrystalline wax, ethylene-vinyl acetate copolymers, and other additives.

The wax agglomeration agent serves to separate wax from the fibers in the pulp furnish and allow the separated wax to aggregate and form particles that can be removed. Suitable wax agglomeration agents according to the invention can include a mineral oil, a polybutene, a petroleum-based aliphatic hydrocarbon, a synthetic alcohol, a vegetable oil, an ester derivative of a vegetable oil, or mixture thereof.

A variety of mineral oils can be used according to the methods of the invention as wax agglomeration agents. Suitable mineral oils include light grade oils with a Saybolt viscosity as low as about 40 (SUS@100° F., ASTM D445) as well as heavy grade oils with a Saybolt viscosity as high as about 1000. In some embodiments, mineral oils have a viscosity in the range of about 70 to about 100 (SUS@100° F., ASTM D445). Example mineral oils include Parol 70 and 100 (Penreco), Drakeol 7 and 10 (Penreco), and Semtol 70 and 100 (Crompton). In some embodiments, the mineral oil has a relatively high viscosity (and relatively high flash point) which can help limit introduction of often undesirable volatile organic compounds. In some embodiments, the mineral oil is an oil approved by the Food and Drug Administration (FDA) which can be used, for example, for recycled linerboard. Approved oils would typically be white technical or NF grade oils with approval for at least indirect use in food. In some embodiments, the mineral oil is a mixture of paraffinic (aliphatic) and naphthenic (cycloaliphatic) carbons, with relatively low levels of aromatic carbons.

In some embodiments, the mineral oil has a viscosity of about 40 SUS@100° F. to about 1000 SUS@100° F.

In some embodiments, the mineral oil has a viscosity of about 50 SUS@100° F. to about 200 SUS@100° F.

In some embodiments, the mineral oil has a viscosity of about 70 SUS@100° F. to about 100 SUS@100° F.

In some embodiments, the mineral oil has an average molecular weight of about 190 to about 670.

In some embodiments, the mineral oil has an average molecular weight of about 200 to about 430.

In some embodiments, the mineral oil has an average molecular weight of about 330 to about 370.

A variety of polybutenes can also be used according to the invention as wax agglomeration agents. Example polybutenes include Indopol L-6, L-8, L-14, L-50, H-7, H-8, and H-15 from BP Amoco Chemical Company.

A variety of petroleum-based aliphatic hydrocarbons can also be used according to the invention as wax agglomeration agents. Example petroleum-based aliphatic hydrocarbons include dearomatized aliphatic hydrocarbons such as Exxsol™ D60, Exxsol™D80, Exxsol™ D110, and Exxsol™ D130 from ExxonMobil Chemical and aliphatic mineral spirits such as Shellsol D60, Shellsol D80, and Shellsol D100 from Shell Chemicals.

A variety of synthetic alcohols can also be used according to the invention as wax agglomeration agents. Example synthetic alcohols include Exxal™ 10, Exxal™ 11, Exxal™ 12, Exxal™ 13, and Acropol 35 from ExxonMobil Chemical.

A variety of vegetable oils and ester derivatives of vegetable oils can also be used as wax agglomeration agents. Example vegetable oils include soybean oil, canola oil, and corn oil. Example ester derivatives of vegetable oils include methyl esters of soy bean oil, such as SoyGold 1000, SoyGold 2000 and SoyGold 2100 from Ag Environmental Products, L.L.C., and Soy Methyl Esters from Columbus Foods.

Suitable wax agglomeration agent treatment levels (or amounts) include any amount effective to aid formation of separable wax particles. An example amount is about 0.5 to about 40 lb/ton (#/T) of dry weight of pulp. In some embodiments, the treatment level is about 1 to about 20 lb/ton. In yet further embodiments, the treatment level is about 2 to about 8 lb/ton. Alternatively, the treatment level can be measured as the weight ratio of wax agglomeration agent to wax in the pulp furnish such as, for example, about 0.05:1 to about 0.5:1 or about 0.1:1 to about 0.4:1. The optimum dosage will be dependent on the repulping temperature and level of wax in the furnish. Higher levels of treatment are typically needed for lower repulping temperatures and higher levels of wax. If too much agent is used, the wax can fully melt and thus not be as effectively removed in the screens and cleaners.

According the present invention, performance of a mineral oil on wax removal can be further enhanced by additional treatment of the pulp furnish with a surfactant. Suitable surfactants include alcohol ethoxylates (e.g., Surfonic, Tergitol, etc.), polyethylene glycol esters (e.g., Pegospere), block copolymers of ethylene oxide and propylene oxide (e.g., Pluronic), tetra-functional block copolymers derived from the sequential addition of propylene oxide and ethylene oxide (e.g., Tetronic), mixtures thereof and the like. In some embodiments, the surfactant is an alcohol ethoxylate.

The surfactants can have a preferred HLB (hydrophile-lipophile balance) value. In some embodiments, the HLB value is from about 3 to about 16, about 7 to about 13, or about 9 to about 12.

The weight ratio of surfactant to wax agglomeration agent can vary. In some embodiments, the weight ratio is about 1:99 to about 25:75. In further embodiments, the weight ratio is about 1:99 to about 15:85. In yet further embodiments, the weight ratio is about 5:95 to about 10:90.

Surfactant can be added to the pulp furnish in any suitable manner. In some embodiments, the surfactant can be added to the pulp furnish separately from the wax agglomerate agent such as, for example, through separate feeding lines. For example, the surfactant can be added prior to, after, or concurrently with the wax agglomeration agent. In other embodiments, the wax agglomeration agent and surfactant can be combined to form a mixture (optionally containing other agents) prior to addition, and the pulp furnish is then treated with the mixture.

The performance of a mineral oil or a mixture of mineral oil and surfactant on wax removal of pulp furnish can be further enhanced by addition of a base. The base can be selected from but not limited to sodium carbonate (soda), sodium hydroxide, potassium hydroxide, sodium silicates, sodium phosphates, potassium phosphates, and sodium borates. In some embodiments, the base is sodium carbonate. In some embodiments, the base is sodium hydroxide.

Any suitable amount of base effective to improve wax separation and removal can be added. In some embodiments, the weight ratio of base to wax agglomeration agent is about 10:1 to about 0.5:1, about 7.5:1 to about 0.75:1, or about 5:1 to about 1:1.

The base can be directly added to the pulp on its own (e.g., separate from other agents) or in combination with other treatment agents. In some embodiments, the base is mixed with mineral oil, surfactant, or both mineral oil and surfactant prior to addition, and the resulting mixture is used to treat the pulp furnish. In some embodiments, the wax agglomeration agent, surfactant, and base are premixed together with water and optionally a stabilizer forming an emulsion which is then used to treat the pulp furnish.

The present invention further contemplates compositions containing a mineral oil and a surfactant useful for treatment of wax-containing pulp furnish. In some embodiments, the composition contains a mineral oil and an alcohol ethoxylate. Suitable weight ratios of surfactant to mineral oil in the compositions of the invention correspond to 1:99 to about 25:75, about 1:99 to about 15:85, or about 5:95 to about 10:90. Example mineral oils and surfactants suitable for the compositions of the invention are provided herein, infra and supra.

Compositions of the invention can further include a base. In some embodiments, the compositions are characterized by a weight ratio of base to mineral oil of about 10:1 to about 0.5:1, about 7.5:1 to about 0.75:1, or about 5:1 to about 1:1. Example suitable bases are provided herein, infra and supra.

Compositions of the invention can further include water, optionally forming an emulsion.

The methods of the invention include the treatment of a pulp furnish with the wax agglomeration agent described herein and removal of the resulting wax particles, thereby effectively separating wax from the fibers in the pulp. The treatment step is typically carried out under conditions effective for generating separable wax particles from the fiber-wax mixture of the pulp. Suitable conditions can involve sufficient mixing of the pulp furnish (typically a fiber slurry) and wax agglomeration agent (and optionally other agents) for a duration and vigor effective to promote wax agglomeration and separation from the fibers. The separation step can be carried out by any suitable means including screening and reverse cleaning techniques as, for example, typically employed in the pulp and paper industry. Screens useful for the invention include, for example, fine slotted screens. Suitable cleaners for the invention include reverse centrifugal cleaners, which can remove low density contaminants, including wax. Larger particles are typically removed more efficiently in the reverse cleaners.

In some embodiments, at least one step in the methods of wax removal described herein is carried out at a temperature below about the melting point of the wax in the pulp furnish. For example, the temperature can be from about ambient (e.g., 70° F.) to about 140° F. In a further example, the temperature can be from about 100° F. to about 130° F. Typical wax melting points are about 130 to about 145° F. for paraffin wax. In some embodiments, both the treatment and wax removal steps are carried out at a temperature below about the melting point of the wax. After removal of wax in the screens and cleaners, the temperature of the system can be raised above the melting point of wax. For example, mills may raise the temperature in the headbox to increase drainage and thus machine speed.

In the context of recycling, for example, treatment of the pulp furnish with the wax agglomeration agent can be made when the furnish is in or entering the repulper; however, treatment can also be made after the pulp furnish has exited the repulper. Treatment in the repulper can provide sufficient time for the wax agglomeration agent to interact with the wax and help remove the wax from the fiber. It is believed that the wax agglomeration agent softens the wax by lowering the wax melting point. Released wax particles can then aggregate together, thus allowing easier removal. Choice of viscosity of the wax agglomeration agent can affect both wax melting point and aggregation. Lower viscosities are more effective in lowering wax melting point while higher viscosities can be better in aiding aggregation of wax particles.

The present invention further includes methods for increasing wax rejects during the recycling process by carrying out any of the methods described herein such that the total wax particles removed from the pulp furnish (the wax rejects) are more than would be expected for the same or similar process but without treatment of the pulp furnish with a wax agglomeration agent.

The present invention further includes methods for increasing wax particle size in a pulp furnish by carrying out any of the methods described herein wherein the wax particle size is increased compared with wax particles in a pulp furnish treated with no wax agglomeration agent in the same or similar process.

It is appreciated that certain features of the invention, which are, for clarity, described in the context of separate embodiments, can also be provided in combination in a single embodiment. Conversely, various features of the invention which are, for brevity, described in the context of a single embodiment, can also be provided separately or in any suitable subcombination.

In order that the invention disclosed herein may be more efficiently understood, examples are provided below. It should be understood that these examples are for illustrative purposes only and are not to be construed as limiting the invention in any manner.

### EXAMPLES

The following examples demonstrate various aspects of the invention. Unless otherwise specified, the following laboratory test method was used to evaluate different treatments.

Waxed vegetable boxes were obtained from a waxed box plant in Jacksonville, Fla. The type of wax coating on the waxed board was cascade, and the boxes were used for packing vegetables. The waxed boards were cut into pieces of about 1″×1″ in size and disintegrated in a TAPPI disintegrator at ambient temperature for 10 minutes. Large wax particles were then washed out, followed by dewatering. The dewatered waxed pulp was then stored in a cold room before use. Unwaxed board was also collected from the same waxed box plant and cut into 1″×1″ in size for use.

The repulping device was a Waring blender equipped with a 5″×10″ silicone heating pad that was connected to a digital temperature controller and was mounted on a motor that was connected to a digital controller.

Unless specified, a portion of cut-up unwaxed board and a portion of the above dewatered waxed pulp with the balance being tap water were added to the Waring blender to make 400 grams of OCC (old corrugated containers) stock that had a consistency of either 4% or 5% by weight of solids and a wax content from 2.66 to 0.49% based on dry weight. The stock was mixed at 300 rpm and the treatment was added. The temperature was then gradually raised to the specified value while increasing the blade rotation speed to 1500 rpm over a period of 45 minutes. Repulping continued at the specified temperature and 1500 rpm for 30 minutes.

At the end of repulping, the pulp was divided into four equal aliquots in four 2-liter flasks. The flasks were filled with tap water to almost full and placed on a four place magnetic stirrer to slowly rotate the diluted pulp at 300 rpm for 10 minutes. This allowed agglomerates of wax particles to float to the top surface. These wax agglomerates were collected on a Whatman filter paper using a Q-tip. This flotation process was repeated an additional time to assure that most of the wax agglomerates were collected. The wax agglomerates on the filter paper were air-dried and weighed. This flotation process was used to imitate the action of reverse cleaners in paper mills.

The pulp remaining in the flasks was run through a Somerville screen with 0.006″ slots for 10 minutes. The rejects from screening were collected on a Whatman filter paper and air dried. The air-dried rejects pat was placed in a 4-oz glass bottle for wax analysis by hexane extraction.

The accepts from the screening were collected on a sieve of mesh No. 40, which had a mesh size of 0.425 mm. Two aliquots of about 3 grams dry weight of the wet pulp were placed in two 4-oz. glass bottles and dried in an oven at 105° C. overnight.

To analyze wax content in the accepts and the rejects from the screening, about 50 mL of hexane of analytical grade was added to the bottle containing the sample to be analyzed. The bottle was placed on a shaker to shake at 250 rpm for 90 minutes. Then the hexane was poured into an aluminum tray, which was placed on a hot plate at 100° C. to let solvent evaporate off. After evaporation for 2 hours, the wax left in the tray was weighed.

Efficacy of wax removal in the repulping test was evaluated by the terms defined as follows:
Agglomerated wax reject rate (%): The weight percent of wax agglomerates collected from floating diluted OCC pulp in flask after repulping in the total wax existing in OCC pulp prior to repulping.
Wax in Accepts (%): The wax content in accepted pulp after screening.

### Example 1

This example compares the wax removal efficacy of mineral oil and two other hydrocarbon solvents, d-limonene and orange oil. The mineral oil used was Parol 70, having Saybolt viscosity of 70 and supplied by Penreco, A Division of Pennzoil Products Company. D-limonene and orange oil were supplied by Florida Chemical Company. The OCC pulp used in the test consisted of 14.4 grams of unwaxed board and 1.6 gram dry weight of a dewatered waxed pulp that contained 26.6% wax. The final OCC pulp had a wax content of 2.66% wax on a dry weight basis. The repulping temperature was 120° F. The results of the test are listed in Table 1. As can be seen, all three tested chemicals increased agglomerated wax reject rate over the control, but the mineral oil significantly outperformed the d-limonene and orange oil.

TABLE 1

| Treatment | Aggl. wax reject rate, % |
|---|---|
| control | 7.5 |
| 5.4 #/T Parol 70 | 29.9 |
| 5.4 #/T d-Limonene | 11.8 |
| 5.4 #/T Orange Oil | 17.3 |

### Example 2

This example demonstrates the wax removal efficacy of mineral oil at repulping temperatures ranging from 110° F. to 125° F. The mineral oil used is Parol 70, having Saybolt viscosity of 70 and supplied by Penreco, A Division of Pennzoil Products Company. The OCC pulp used in the test consisted of 14.4 grams of unwaxed board and 1.6 gram dry weight of a dewatered waxed pulp that contained 26.6% wax. The final OCC pulp had a wax content of 2.66% wax on a dry weight basis. Each repulping test was run in duplicate and results were averaged from two runs. The results of the test are shown in Table 2. As can be seen, at the three tested temperatures, the mineral oil increased agglomerated wax and reduced wax content in accepted fibers.

TABLE 2

| Repulping | | Aggl. wax | Wax in |
|---|---|---|---|
| Temperature | Treatment | reject rate, % | accepts, % |
| 110° F. | Control | 6.6 | 1.15 |
| | 5.4 #/T Parol 70 | 33.6 | 0.93 |
| 120° F. | Control | 12.3 | 1.24 |
| | 5.4 #/T Parol 70 | 42.4 | 0.88 |
| 125° F. | Control | 12.2 | 1.12 |
| | 5.4 #/T Parol 70 | 29.7 | 0.91 |

### Example 3

This example demonstrates the wax removal efficacy of mineral oil at repulping temperatures ranging from 106° F. to 130° F. The mineral oil used was Parol 100, having Saybolt viscosity of 100 and supplied by Penreco, A Division of Pennzoil Products Company. The OCC pulp used in the test consisted of 15.0 grams of unwaxed board and 1.0 gram dry weight of a dewatered waxed pulp that contained 26.5% wax. The final OCC pulp had a wax content of 1.66% wax on a dry weight basis. The results of the test are listed in Table 3. As can be seen, at the three tested temperatures, the mineral oil increased agglomerated wax and reduced wax content in accepted fibers.

TABLE 3

| Repulping | | Aggl. wax | Wax in |
|---|---|---|---|
| Temperature | Treatments | reject rate (%) | accepts, % |
| T = 106° F. | control | 5.2 | 0.62 |
| | 2.7 #/T Parol 100 | 13.3 | 0.56 |
| | 5.4 #/T Parol 100 | 24.5 | 0.59 |
| | 8.1 #/T Parol 100 | 37.6 | 0.57 |
| T = 120° F. | control | 7.8 | 0.70 |
| | 2.7 #/T Parol 100 | 21.6 | 0.58 |
| | 5.4 #/T Parol 100 | 23.8 | 0.63 |
| | 8.1 #/T Parol 100 | 28.8 | 0.62 |
| T = 130° F. | control | 6.1 | 0.65 |
| | 2.7 #/T Parol 100 | 22.5 | 0.57 |
| | 5.4 #/T Parol 100 | 19.9 | 0.58 |
| | 8.1 #/T Parol 100 | 14.4 | 0.57 |

### Examples 4-5

These examples illustrate effectiveness of various grades of mineral oil with a wide range of properties on wax removal of OCC recycling. One Parol mineral oil and three Semtol mineral oils were used in this example. Parol mineral oil was supplied by Penreco, A Division of Pennzoil Products Company, and Semtol mineral oils were supplied by Witco Refined Products, Crompton Corporation. The two key properties of the mineral oils and experimental results are listed together in Table 4. The experimental method of conducting tests was essentially the same as in Examples 1 to 3 except the OCC pulp used in this example contained 0.93% wax and consisted of 0.7 g dry weight of dewatered waxed OCC pulp and 19.3 g of unwaxed board. Repulping temperature was 120° F. Total repulping time was 60 minutes for Example 4 and 75 minutes for Example 5. All mineral oils were added at 4.1#/T in both examples. As can be seen in Example 4 (Examples 4-1, 4-2, 4-3, and 4-4), the three mineral oils having Saybolt viscosity ranging from 40 SUS to 350 SUS and molecular weights ranging from 190 to 541 demonstrate capability of increasing rejects of wax agglomerates. The mineral oil with a lower molecular weight or a lower viscosity was more capable of reducing wax content in accept fibers while mineral oils with a higher molecular weight or a higher viscosity had a higher residue of the mineral oils in accept fibers, which made the wax content in accept fibers appear to be higher. In Example 5 (Examples 5-1 and 5-2), two tested mineral oils had a similar performance on increasing rejects of wax agglomerates even though they had a widely different Saybolt viscosity, which were 40 SUS and 500 SUS, respectively.

TABLE 4

| | | | | Aggl. | |
|---|---|---|---|---|---|
| | Name of | | | wax | Wax in |
| | mineral | Viscosity | Molecular | reject | accepts, |
| Example | oils | (SUS@100 F.) | Weight | rate, % | % |
| 4-1 | none | | | 3.7 | 0.39 |
| 4-2 | Semtol 40 | 40 | 190 | 10.4 | 0.33 |
| 4-3 | Parol 100 | 100 | ˜370 | 14.3 | 0.38 |
| 4-4 | Semtol 350 | 350 | ˜490 | 17.1 | 0.41 |
| 5-1 | Semtol 40 | 40 | 190 | 12.0 | 0.31 |
| 5-2 | Semtol 500 | 500 | 541 | 12.3 | 0.35 |

### Example 6

This example demonstrates that soybean oil can also be used to remove wax in OCC recycling. The soybean oil used was intended for cooking and was purchased from a local grocery store. The experimental method was essentially the same as in Examples 4 to 5. The OCC pulp had a wax content of 0.93% by dry weight and consistency of 5%, but repulping temperature was 105° F. and total repulping time was 75 minutes. The results are listed in Table 5. As can be seen, increasing addition of soybean oil increased rejects of wax agglomerates.

TABLE 5

| | | Aggl. wax |
|---|---|---|
| Example | Treatment | reject rate, % |
| 6-1 | 4.5 #/T Soybean oil | 9.7 |
| 6-2 | 6.8 #/T Soybean oil | 15.5 |
| 6-3 | 9.0 #/T Soybean oil | 28.1 |

### Example 7

This example demonstrates that polybutenes and esters of vegetable oils can also be used to remove wax in OCC recycling. Results are listed in Table 6. Indopol L-14 is a polyisobutene and manufactured by BP Amoco Chemical Company. SoyGold 1000 and 2000 are methyl esters of soybean oil and supplied by AG Environmental Products L.L.C. The OCC pulp used in tests consisted of 50% of NRLB (non-recycled liner board) pulp and 50% of dewatered waxed OCC and had a wax content of ˜15%. Repulping was conducted in a Waring blender at 120° F., 5% consistency, and 1500 rpm for 90 minutes. At the end of repulping, the pulp was run through a Somerville screen with 0.006″ slots to collect rejects and accepts. Wax in rejects and accepts was analyzed gravimetrically by hexane extraction. As can be seen in Table 6, all three tested fluids were capable of increasing reject wax and decreasing wax content in accept fibers.

TABLE 6

| | Aggl. wax | Wax in |
|---|---|---|
| Treatment | reject rate, % | accepts, % |
| control | 26.4 | 6.55 |
| 30 #/T L-14 | 49.5 | 4.24 |
| 30 #/T Soy Gold 1000 | 62.6 | 4.69 |
| 30 #/T Soy Gold 2000 | 55.3 | 3.85 |
| 30 #/T Soy Gold 2000 | 56.4 | 4.31 |

### Example 8

This example further demonstrates that synthetic alcohols and other agents can be used to remove wax in OCC recycling. Results are listed in Table 7. Wax Out™ is a cleaning aid which contains 70% kerosene and 30% D-limonene and is supplied by Fisher Scientific. Exxsol D100, D80, and D60 are petroleum-based aliphatic hydrocarbons and supplied by ExxonMobil Chemical. Exxal 13 is an isododecanol and also supplied by ExxonMobil Chemical. The OCC pulp used in tests consisted of 100% dewatered waxed OCC and had a wax content of 30%. Repulping was conducted in a Waring blender at 120° F., 5% consistency, and 1500 rpm for 45 minutes. At the end of repulping, two aliquots of ˜45 g pulp were transferred into two 2-liter flasks. The flasks were then filled with water to almost full and placed on a magnetic stirrer to separate wax agglomerates from fibers through flotation. The remaining slurries in the flasks were filtered through a sieve of mesh No. 40, which had a mesh size of 0.425 mm. The accepted fibers on the screen of the sieve were collected into 4 oz. glass bottles. The fibers in the bottles were dried in an oven overnight at 105° C. The wax contents in the accepted fibers were analyzed gravimetrically by hexane extraction. As can be seen in Table 7, all tested fluids demonstrate the capability of increasing rejects of wax agglomerates and decreasing wax content in accept fibers.

TABLE 7

| | Aggl. wax | Wax in |
|---|---|---|
| Treatment | reject rate, % | accepts, % |
| None | 6.4 | 21.8 |
| 27#/T Wax Out ™ | 30.9 | 17.8 |
| 27#/T Exxsol D110 | 37.4 | 18.1 |
| 27#/T Exxsol D80 | 36.5 | 18.8 |
| 27#/T Exxsol D60 | 39.0 | 17.9 |
| 27#/T Exxal 13 | 21.3 | 17.5 |

### Examples 9-11

These examples demonstrate that a variety of surfactants with a wide range of HLB (hydrophile-lipophile balance) values are capable of enhancing wax removal efficacy of mineral oils. Three types of surfactants used in this example included: 1) Pluronic® surfactants, block copolymers of ethylene oxide (EO) and propylene oxide (PO) and supplied by BASF; 2) Tetronic® surfactants, tetra-functional block copolymers derived from the sequential addition of propylene oxide and ethylene oxide and also supplied by BASF; 3) Surfonic® L series surfactants, linear alcohol ethoxylates and supplied by Huntsman Corporation. Surfactants were pre-mixed with mineral oil Parol 70 to have a concentration of 5 wt %. The experimental method used was essentially the same as in Examples 1 to 3. The treatments included mixtures of mineral oil and surfactants or just mineral oil alone for comparison, and were added at the dosage of 5.1#/T. The results are listed in Table 8. As can be seen in Example 9, two Pluronic® surfactants having HLB values of 3 and 7, respectively, demonstrated effectiveness of enhancing mineral oil's performance on wax removal. In Example 10, one Tetronic® surfactant having an HLB value of 15 and three Surfonic® L series surfactants having HLB values from 12.4 to 14.4 were also effective. In Example 11, two additional Surfonic® L series surfactants with HLB values from 9.0 to 15.2, plus one that had already been tested in Example 10, were effective. These surfactants help mineral oil to further increase the reject rate of wax agglomerates and reduce residue wax in pulp in OCC repulping.

TABLE 8

| | Trade Name of | HLB of | Aggl. Wax | Wax in |
|---|---|---|---|---|
| Example | Surfactant | surfactant | reject rate, % | accepts, % |
| 9-1 | No treatment | | 7.5 | 2.3 |
| 9-2 | No surfactant | | 28.0 | 2.0 |
| 9-3 | Pluronic L61 | 3 | 33.6 | 1.81 |
| 9-4 | Pluronic L62 | 7 | 33.9 | 1.80 |
| 10-1 | No surfactant | | 31.7 | 1.90 |
| 10-2 | Tetronic 904 | 15 | 35.2 | 1.71 |
| 10-3 | Surfonic L24-9 | 13.0 | 36.4 | 1.72 |
| 10-4 | Surfonic L24-12 | 14.4 | 37.9 | 1.94 |
| 10-5 | Surfonic L12-6 | 12.4 | 38.1 | 1.73 |
| 11-1 | No surfactant | | 33.2 | 1.92 |
| 11-2 | No surfactant | | 35.9 | 2.01 |
| 11-3 | Surfonic L12-3 | 9.0 | 38.3 | 1.84 |
| 11-4 | Surfonic L12-3 | 9.0 | 38.5 | 1.88 |
| 11-5 | Surfonic L24-9 | 13.0 | 39.2 | 1.86 |
| 11-6 | Surfonic L24-9 | 13.0 | 39.8 | 1.71 |
| 11-7 | Surfonic L46-16 | 15.2 | 40.4 | 1.86 |

### Examples 12-13

These examples further demonstrate activity of various surfactants to enhance wax removal efficacy of mineral oils. Surfactants used in Example 12 were Surfonic® L24-7 (HLB=11.9) and in Example 13 were Tetronic® 90R4 (HLB=7), and Pegospere® 400DL (HLB=7). Surfonic® L24-7 is a linear alcohol ethoxylate and supplied by Huntsman Corporation. Tetronic® 90R4 is a tetra-functional block copolymers derived from the sequential addition of propylene oxide and ethylene oxide and supplied by BASF. Pegospere® 400DL is a polyethylene dilaurate and supplied by Lonza Secialty Chemicals. 5% of surfactants and 95% mineral oil Parol 70 were pre-mixed together and added to OCC pulp for repulping at a dosage of 5.1 #/T. The OCC repulping experiments were conducted as follows: 5 g of dewatered waxed pulp containing ˜28 wt.% wax was mixed with 75 g of dewatered NRLB (non-recycled liner board) and the balance water in a TAPPI disintegrator for 10 minutes to make an OCC pulp with 4% consistency. An aliquot of 400 grams of the OCC pulp was repulped in a Waring blender with treatment a mixture of surfactant and mineral oil or mineral oil alone (except control) at 120° F. and 1500 rpm for 30 minutes. At the end of repulping, the pulp was divided into four equal aliquots in four 2-liter flasks. The flasks were filled with tap water to almost full and placed on a four place magnetic stirrer to slowly rotate the diluted pulp at 300 rpm for 10 minutes. This allowed agglomerates of wax particles to float to the surface. These wax agglomerates were collected on a Whatman filter paper using a Q-tip. As can be seen from Table 9, the treatments containing the surfactants further increase the reject rate of wax agglomerates.

TABLE 9

| | Trade Name of | HLB of the | Aggl. wax |
|---|---|---|---|
| Example | Surfactant | surfactants | reject rate, % |
| 12-1 | No treatment | | 1.3 |
| 12-2 | No surfactant | | 15.3 |
| 12-3 | Surfonic L24-7 | 11.9 | 21.0 |
| 12-4 | Tetronic90R4 | 7 | 21.5 |
| 13-1 | No treatment | | 3.0 |
| 13-2 | No surfactant | | 20.4 |
| 13-3 | PEG400DL | 7 | 29.6 |

### Example 14

This example illustrates the effect of surfactant concentration in a mixture of surfactant and mineral oil on its efficacy of wax removal in OCC recycling. The surfactant was Tergitol® 15-S-5, which is a linear secondary ethoxylate supplied by Dow Chemical Company and has a HLB value of 10.6. The mineral oil used in this example was Parol 70. Tergitol 15-S-5 and Parol 70 were pre-mixed at three concentrations as listed in Table 10. The experimental method used in this example is essentially the same as in Examples 1 to 3. The OCC pulp had a consistency of 4% and a wax content of 1.66% on dry weight. Repulping temperature was 120° F. 5.1#/T of treatment was added to OCC repulping in each test. The test results are listed in Table 10. As can be seen, with increasing the ratio of the surfactant in the mixtures, wax content in fibers continued to decrease, but rejects of wax agglomerates increased at first and, after passing a maximum, then started to decrease.

TABLE 10

| | 15-S-5, | Aggl. wax | Wax in |
|---|---|---|---|
| Example | wt. % | reject rate, % | accepts, % |
| 14-1 | 0.0 | 33.3 | 0.58 |
| 14-2 | 6.8 | 43.3 | 0.56 |
| 14-3 | 11.3 | 44.2 | 0.56 |
| 14-4 | 15.7 | 36.7 | 0.54 |

### Example 15

This example illustrates synergism of the wax agglomeration agent with a base on wax removal in OCC recycling. The wax agglomeration agent was noted as 198B11, which consisted of 90% of mineral oil Parol 100 and 10% of Surfonic L24-5 surfactant on a volume basis. The base was soda, Na₂CO₃. Addition of 198B11 was 6.4#/T and soda was 18.9#/T based on dry weight of fibers. The OCC pulp used in this example contained 0.93% wax and consisted of 0.7 g dry weight of dewatered waxed OCC pulp and 19.3 g of unwaxed board. Repulping temperature was 108° F. The results are listed Table 11. As can be seen, the use of a combination of 198B11 with soda produced an increase in wax agglomerates higher than the combined increases when 198B11 and soda were used alone. Furthermore, the use of a combination of 198B11 with soda produced a decrease in wax content in accepts larger than the combined decreases when 198B11 and soda were used alone. As evidenced, soda further enhanced the wax removal efficacy of the mixture of the mineral oil and the surfactant.

TABLE 11

| | Aggl. wax | Wax in |
|---|---|---|
| Treatment | reject rate, % | accepts, % |
| No treatment | 1.7 | 0.36 |
| 18.9 #/T Soda | 6.3 | 0.33 |
| 6.4#/T 198B11 | 30.1 | 0.34 |
| 6.4#/T 198B11 + | 41.3 | 0.26 |
| 18.9#/T Soda | | |

### Example 16

### Pilot Plant Trial 1

In this example, the wax removal efficacy of mineral oil was demonstrated on a pilot scale. The pilot trials were run in the Stock Preparation Laboratory of Hercules, Inc. in Jacksonville, Fla. as follows. About 240 gallons of Jacksonville city water, which had been pre-heated to about 100° F., was discharged to the pulper. While maintaining the water in pulper agitated at low speed, 100# OCC board was added. The OCC board consisted of 95# unwaxed corrugated board and 5# waxed corrugated board. Both waxed and unwaxed boards were directly obtained from a box plant in Jacksonville, Fla. The type of wax coating on the waxed board was cascading, and the boxes were used for packing vegetables.

The target consistency in the pulper was about 5%. After adding all OCC board, the lid of the pulper was closed, and the speed of agitator was increased to 500 rpm. When the temperature of the pulp spontaneously increased to about 116° F. at about 30 minutes, the agitator's speed was reduced to 450 rpm and the lid was opened. For the second run of the trial, the treatment of 5#/T mineral oil (Parol 70) was added. Then, repulping was continued for another 30 minutes. The total repulping time was 60 minutes.

At the end of repulping, the OCC stock in the pulper was discharged into a storage tank, in which the stock was further diluted to about 1.2% using city water. The diluted stock was run through a 3-inch X-clone (through-flow cleaner) at a feed flow rate of 45 gpm and a feed pressure of 25 psi. The accepts had a flow rate of 40 gpm and pressure of 10 psi and were discharged into a second storage tank. Representative accept samples were taken from the tank and run through Somerville screening with 0.006 inch slots. The accept fibers from the Somerville screening were dried in an oven at 105° C. overnight and then analyzed for wax content by hexane extraction and gravimetric method.

In order to collect wax agglomerates, the reject flow from the cleaner was periodically collected in a 2-liter flask, which was then placed on a stirrer to slowly rotate at 300 rpm for 10 minutes. This allowed agglomerates of wax particles to float to the surface. These wax agglomerates were collected on a Whatman filter paper using a Q-tip. This flotation process was repeated one more time to assure that most of wax agglomerates were collected. The wax agglomerates on the filter paper were air-dried and weighed.

The results of the trial are listed in the Table 12. As can be seen, final accept wax content in the second run with the treatment of 5#/T mineral oil was lower than it was in the control run, even though the pulp in the second run initially had a higher wax content. Also, the second run generated much more wax agglomerates than the first run did.

TABLE 12

Run No.

| | Run #1 | Run #2 |
|---|---|---|
| Treatments | Control | 5 #/T Parol 70 |
| Initial wax content in pulp, % | 1.52 | 1.98 |
| Final accept wax content, % | 0.618 | 0.421 |
| Rejects of wax agglomerates, g/gal | 0.052 | 0.120 |

### Example 17

### Pilot Plant Trial 2

In this example, the wax removal efficacy of mineral oil was demonstrated on a pilot scale. The pilot trials were run in the Stock Preparation Laboratory of Hercules, Inc. in Jacksonville, Fla. as follows: About 240 gallons of Jacksonville city water without pre-heated was discharged into the pulper. While maintaining the water in pulper agitated at low speed, 100# OCC board was added. The OCC board consisted of 95# unwaxed corrugated board and 5# waxed corrugated board. Both waxed and unwaxed board were directly obtained from a box plant in Jacksonville, Fla. The type of wax coating on the waxed board was cascading and the boxes were used for packing vegetables.

The target consistency in the pulper was about 5%. After adding all OCC board, the specified treatments were added in the second run and the lid of the pulper was closed. Then, the speed of agitator was increased to 450 rpm and continued to run for 105 minutes. The temperature of the pulp spontaneously increased to and stabilized at 111° F. to 113° F. due to the strong agitation in the pulper.

At the end of repulping, the OCC stock in the pulper was discharged into a storage tank, in which the stock was further diluted to about 1.2% using city water. The diluted stock was run through a 3-inch X-clone (through-flow cleaner) at a feed flow rate of 45 gpm and a feed pressure of 25 psi. The accepts had a flow rate of 40 gpm and pressure of 10 psi and flowed into a second storage tank. Representative accept samples were taken from the tank and run through Somerville screening with 0.006 inch slots. The accepted fibers from the Somerville screening were dried in an oven at 105 ° C. overnight and then analyzed for wax content by hexane extraction and gravimetric method.

In order to collect wax agglomerates, the rejects flow from the cleaner was periodically collected in a 2-liter flask, which was then placed on a stirrer to slowly rotate at 300 rpm for 10 minutes. This allowed agglomerates of wax particles to float to the surface. These wax agglomerates were collected on a Whatman filter paper using a Q-tip. This flotation process was repeated one more time to assure that most of wax agglomerates were collected. The wax agglomerates on the filter paper were air-dried and weighed.

The results of the trial are listed in the Table 13. As can be seen, final accept wax content in the second run with the treatment of 6#/T mineral oil (Parol 70) was lower than it was in the control run, even though the pulp in the second run initially had a higher wax content. Also, the second run generated much more wax agglomerates than the first run did.

TABLE 13

Run No.

| | Run #1 | Run #2 |
|---|---|---|
| Treatments | control | 6 #/T Parol 70 |
| Initial wax content in pulp, % | 1.62 | 1.72 |
| Final accept wax content, % | 0.614 | 0.562 |
| Reject of wax agglomerates, g/gal | 0.051 | 0.121 |

### Example 18

This example illustrates small wax particles agglomerated into much bigger wax particles when a wax agglomeration agent is used during OCC repulping. The wax agglomeration agent consisted of 90% mineral oil Parol 100 and 10% Surfonic L24-5 surfactant on a volume basis. There were four runs, which had additions of wax agglomeration agent at 0#/T (Run 1), 2.3#/T (Run 2), 4.3#/T (Run 3), and 6.4#/T (Run 4) based on dry weight of fibers, respectively. The OCC pulp used in this example contained 0.93% wax and consisted of 0.7 g dry weight of dewatered waxed OCC pulp and 19.3 g of unwaxed board. Repulping temperature was 108° F. After the repulping was completed and rejects of agglomerated wax were collected on the filter paper, photographs of the wax agglomerates from each run of experiments were taken under microscope and analyzed. It was observed in Run 1 (no addition of wax agglomeration agent) that not only was the amount of rejected wax particles less than in the other Runs (i.e., particle population was relatively low) and the average size of the particles smaller than in the other Runs, but also the surfaces of the wax particles were smooth, indicating little agglomeration. With increasing amounts of wax agglomeration agent (Runs 2-4), both the amount of rejected wax particles (i.e., particle population) and particle size increased visibly. Most interestingly, surfaces of rejected wax particles in Runs 2-4 were coated with many smaller wax particles, suggesting that the collection of small wax particles increased with increasing addition of wax agglomeration agent.

Various modifications of the invention, in addition to those described herein, will be apparent to those skilled in the art from the foregoing description. Such modifications are also intended to fall within the scope of the appended claims. Each reference, including all patents, patent applications, and journal literature, cited in the present application is incorporated herein by reference in its entirety.

What is claimed is:

1. A method for reducing wax content of a pulp furnish, comprising:
a) treating a pulp furnish comprising fibers and wax with a wax agglomeration agent effective to separate the wax from the fibers and form wax particles,
wherein said wax agglomeration agent comprises a mineral oil, a polybutene, a petroleum-based aliphatic hydrocarbon, a synthetic alcohol, a vegetable oil, or an ester derivative of a vegetable oil; and
b) removing said wax particles from said pulp furnish to produce a pulp furnish having reduced wax content compared with the pulp furnish prior to said treating.

2. The method of claim 1 wherein the amount of said wax particles removed from said pulp furnish is increased relative to the amount of wax particles removed from said pulp furnish treated with no wax agglomeration agent.

3. The method of claim 1 wherein the average size of said wax particles removed from said pulp furnish is increased relative to the average size of wax particles removed from said pulp furnish treated with no wax agglomeration agent.

4. The method of claim 1 wherein said treating and said removing steps are carried out at a temperature below about the melting point of the wax.

5. The method of claim 4 wherein said temperature is from about ambient to about 140° F.

6. The method of claim 1 wherein said wax agglomeration agent comprises a mineral oil.

7. The method of claim 6 wherein said mineral oil has a viscosity of about 40 SUS@100° F. to about 1000 SUS@100° F. or an average molecular weight of about 190 to about 670.

8. The method of claim 6 wherein said mineral oil has a viscosity of about 50 SUS@100° F. to about 200 SUS@100° F. or an average molecular weight of about 200 to about 430.

9. The method of claim 1 further comprising treating said pulp furnish with a surfactant.

10. The method of claim 9 wherein said surfactant comprises an alcohol ethoxylate.

11. The method of claim 9 wherein said surfactant has an HLB value from about 3 to about 16.

12. The method of claim 9 wherein the weight ratio of surfactant to wax agglomeration agent is about 1:99 to about 25:75.

13. The method of claim 9 wherein the weight ratio of surfactant to wax agglomeration agent is about 5:95 to about 10:90.

14. The method of claim 9 wherein said wax agglomeration agent and said surfactant are added separately to said pulp furnish.

15. The method of claim 9 wherein said wax agglomeration agent and said surfactant are premixed prior to addition to said pulp furnish.

16. The method of claim 1 further comprising treating said pulp furnish with a base.

17. The method of claim 16 wherein the weight ratio of base to wax agglomeration agent is about 10:1 to about 0.5:1.

18. The method of claim 16 wherein the weight ratio of base to wax agglomeration agent is about 7.5:1 to about 0.75:1.

19. The method of claim 16 further comprising treating said pulp furnish with a surfactant.

20. The method of claim 19 wherein said wax agglomeration agent, surfactant, and base are premixed together with water and optionally a stabilizer forming an emulsion which is used for said treating of said pulp furnish.

21. The method of claim 1 wherein the amount of said wax agglomeration agent used in said treating is about 0.5 to about 40 pounds per ton based on dry weight of said pulp furnish.

22. The method of claim 1 wherein the amount of said wax agglomeration agent used in said treating is about 1 to about 20 pounds per ton based on dry weight of said pulp furnish.

23. The method of claim 1 wherein the weight ratio of wax agglomeration agent to wax in said pulp furnish prior to said treating is about 0.05:1 to about 0.5:1.

24. A method for reducing wax content of a recycled pulp furnish, wherein said recycled pulp furnish comprises fibers and about 0.1 to about 5% of wax based on total dry weight of fibers in said pulp furnish;
wherein the steps of said method are carried out at a temperature of about 100° F. to about 130° F.;
said method comprising:
a) treating said recycled pulp furnish with:
i) a mineral oil having a viscosity of about 40 SUS@100° F. to about 1000 SUS@100° F. or an average molecular weight of about 190 to about 670;
ii) a surfactant comprising an alcohol ethoxylate; and
iii) a base, each in an amount effective to separate the wax from the fibers and form wax particles; and
b) removing said wax particles from said recycled pulp furnish to produce a pulp furnish having reduced wax content compared with the recycled pulp furnish prior to said treating.

25. A method for increasing wax particle size in a pulp furnish, comprising:
treating a pulp furnish comprising fibers and wax with a wax agglomeration agent effective to separate the wax from the fibers and form wax particles,
wherein said wax agglomeration agent comprises a mineral oil, a polybutene, a petroleum-based aliphatic hydrocarbon, a synthetic alcohol, a vegetable oil, or an ester derivative of a vegetable oil;
wherein said wax particle size is increased compared with wax particles in a pulp furnish treated with no wax agglomeration agent.
